(19) United States
(12) Patent Application Publication
(10) Pub. No.: US 2026/0093240 A1
(43) Pub. Date: Apr. 2, 2026

(54) SCALABLE CONNECTION SERVICES FOR AUTOMATION DEVICE DATA COLLECTION

(71) Applicant: Rockwell Automation Technologies, Inc., Mayfield Heights, OH (US)

(72) Inventors: Michael J. Anthony, Milwaukee, WI (US); Sharath Chander Reddy Baddam, Twinsburg, OH (US); Sonal R. Dubey, Mayfield Heights, OH (US); Gene Pritsker, Highland Heights, OH (US); Brent R. Johnson, Cleveland Heights, OH (US); Filip Stehlik, Kornatice (CZ); Ondrej Pálenícek, Prague (CZ)

(21) Appl. No.: 18/901,955

(22) Filed: Sep. 30, 2024

(51) Int. Cl. G05B 19/418

(52) U.S. Cl. CPC G05B 19/41835; G05B 2219/31229

(57) ABSTRACT

Dynamic connection and communication services in container orchestration systems. A connection broker is leveraged to overcome a mismatch between stateless connections to data access services and stateful connections to industrial automation devices (IAD) by acting as an intermediary between the stateless and stateful connections. The broker maintains stateless connections between itself and data access services and establishes stateful connections between itself and IADs. The broker manages stateful connections such that any data access service can communicate with the IADs via stateful connections, despite the stateless nature of the connections between the broker and the data access services. The broker receives data requests along the stateless connections, facilitates communication between data access services and IADs, and receives data responses from IADs along the stateful connections. The broker may further reuse a single stateful connection for multiple data requests, reuse a data response for multiple data requests, and replace failed stateful connections.

### BACKGROUND

As edge and cloud computing continue to evolve, container orchestration systems (COS) such as Kubernetes are an increasingly common choice for managing workloads. However, while COSs are capable of executing centralized management of containerized resources, they struggle to provide similar management of industrial automation devices (IAD). IADs, such as drives and controllers, cannot be directly represented as COS resources, meaning they cannot be directly managed by a COS cluster. One particular reason IADs cannot be directly represented as COS resources results from security policies that aim to mitigate risk from unauthorized communication to IADs. Many such security policies are informed by Zero Trust Architecture principles described in NIST® Special Publication 800-207.

One means to overcome obstacles to centrally managing IADs in a COS involves deploying pods and containers to act as proxies for each IAD. These “proxy pods” are responsible for connecting IADs to communication infrastructure of the COS to facilitate communication with the IADs. However, communication with industrial automation devices is traditionally highly stateful. The inherent risk to persons, property, and operational efficiency generally involved in directing industrial automation devices, which can often be large and powerful machines, to operate autonomously prompts this need for stateful connections. To mitigate this risk, communications to IAD are not only commonly based on highly stateful connections, but also regularly employ strict fault tolerances. Where communication between the COS proxy and the industrial automation device fails to satisfy the fault tolerances, operation of the industrial automation device can be delayed or halted altogether.

While this strict fault standard may reduce the likelihood of problematic or dangerous industrial automation device operation, it also results in obstacles to the performance of COS communication services and therefore overall COS performance. In particular, executing fault tolerant communication to industrial automation devices with respect to high performance communication loads (e.g., large volumes of data communicated from many sources in a short period of time) regularly requires significant investment of software resources. In spite of this significant investment of software resources, COSs utilizing proxy pods to facilitate fault tolerant central IAD management remain unable to efficiently scale and load-balance connection services to those proxy pods. As a result, COSs are similarly unable to provide scaled and load-balanced communication services for the IADs corresponding to each proxy pod. As such, improved connection and communication services for COSs are needed.

### SUMMARY

To provide improved connection and communication services in container orchestration systems (COS), the disclosure describes systems and methods for automatically and dynamically managing COS connection and communication services to industrial automation devices. To provide automatic and dynamic connection and communication services, a connection broker of the COS is leveraged. The connection broker manages connections and data requests from stateless entities in the COS to stateful industrial automation devices (IAD).

Disclosed is a system for orchestrating containerized workloads. The container orchestration system (COS) includes multiple data access services and a connection broker. The multiple data access services are configured to receive application requests and to generate data requests based on the application requests. The application requests correspond to industrial automation devices (IAD) that execute industrial automation processes. Each of the multiple data access services processes application requests in order to produce data requests. The connection broker is configured to maintain stateless connections with the data access services and stateful connections to the industrial automation devices. The connection broker is further configured to receive data requests from the data access services and, for each data request, to facilitate data transmission between the data access service that originated the data request and the industrial automation device that is the target of the data request. The transmission is facilitated by the stateless and stateful connections maintained at the connection broker.

In some cases, receiving the data requests from the data access services also includes using a single stateful connections to facilitate the data transmission between the industrial automation device and multiple requesting data access services. In some cases, the connection broker is also configured to identify concurrent requests for the same data from the same industrial automation device. Where concurrent requests seek the same data from the same industrial automation, the connection broker obtains the responsive information once and distributes the information to each of the data access services associated with one of the concurrent requests.

In some cases, the connection broker is also configured to identify where a stateful connection is beyond a connection capacity threshold, and in response, to establish another stateful connection to the same target as the connection at the capacity threshold. In some cases, an application request is a high priority request. In such cases, the connection broker is also configured to establish a dedicated connection for the high priority request such that the corresponding data request communicates with the relevant industrial automation device via a connection that no other data request utilizes. In some cases, the connection capacity threshold is configured such that a dedicated connection is preserved.

In some cases, the COS is implemented in a distributed computing environment with multiple nodes. In such cases, the connection broker spans the multiple nodes, maintains stateless connections to the data access services of each node of the COS, and maintains stateful connections with industrial automation devices. The connection manager facilitates communication between each of the data access services and the industrial automation devices along the stateless and stateful connections. In some cases, one node of the COS may fail. In such cases, the connection broker is also configured to identify where a stateful connection is failing or about to fail, and in response, to establish a new stateful connection to replace the failing instance.

In some cases, the industrial automation devices that the connection broker maintains the stateful connections to are a storage media, an industrial controller, an automation device, or a combination of those examples. In some cases, the application requests include a request to read data. In some cases, the application requests include a request to submit data. A request to submit data may be a write request, a configuration request, or an instruction request. In any case, the request to submit data includes the data to be submitted.

In some cases, the connection broker is configured to identify where no data request requires a particular stateful connection and in response, to disconnect the unrequired stateful connection. In some cases, the connection broker includes multiple containers that can be used to organize and manage data requests. In such cases, each of the containers have a type and receives data requests corresponding to the type. Each of the containers may be a device-specific container, a device-type-specific container, a data-type-specific container, a workload-specific container, or a combination thereof.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operating environment in accordance with some embodiments of the present technology.

FIG. 2 illustrates a connection broker in further detail in accordance with some embodiments of the present technology.

FIG. 3 illustrates another operating environment in accordance with some embodiments of the present technology.

FIG. 4A illustrates a method of orchestrating containerized workloads in accordance with some embodiments of the present technology.

FIG. 4B illustrates another method of orchestrating containerized workloads in accordance with some embodiments of the present technology.

FIG. 4C illustrates another method of orchestrating containerized workloads in accordance with some embodiments of the present technology.

FIG. 5 illustrates a software flow diagram in accordance with some embodiments of the present technology.

FIG. 6 illustrates computing system used in accordance with some embodiments of the present technology.

### DETAILED DESCRIPTION

To provide improved connection and communication services in container orchestration systems (COS), the disclosure describes systems and methods for automatically and dynamically managing COS connection and communication services to industrial automation devices. A connection broker maintains stateless connections with multiple data access services and establishes stateful connections to industrial automation devices (IAD). The data access services act as links to the industrial automation devices, while the connection broker establishes the actual connection to facilitate communication. In particular, the connection broker is responsible for establishing and maintaining stateless connections to the data access services, stateful connections to the industrial automation devices, and facilitating communication between data access services and industrial automation devices through communication pathways that are made up of both stateless and stateful connections.

An industrial automation device is a device that carries out industrial automation processes, such as assembly line automation, automated material handling, automated quality control inspection, automated packaging, automated machining, and the like. A connection broker is leveraged to maintain stateless connections with multiple data access services and to establish stateful connections to industrial automation devices (IAD). The connection broker manages the stateful connections to the IADs such that any data access service can utilize the stateful connectivity and communicate with the IADs, despite the stateless nature of the connections between the connection broker and the data access services.

The connection broker overcomes the mismatch between the stateless and stateful connections by acting as an intermediary between the connections. The connection broker receives data requests along the stateless connections and data responses from IADs along the stateful connections. The connection broker manages the stateful connections to IADs by maintaining communication with the IAD. This allows the connection broker to satisfy the stateful connection of the IAD while allowing data access services to dynamically utilize the stateful connections based on their own communication schedules. Without the connection broker, dynamic connection to or scaling of communication to IADs is likely to offend the fault tolerance associated with the stateful connections, which is likely to result in disrupted operation of the IADs.

The data access services are configurable containers that act as links between workloads and the IADs. The data access services receive I/O requests and convert them to data requests. Each data request includes a target (which IAD the data request corresponds to) and what data the data request seeks to acquire from the corresponding IAD. The target may be any variety of industrial automation device, such as robotic devices, conveyors, sorting machines, and the like. In some cases, the data request is intended to write data to an IAD instead of acquiring data. In those cases, the data request includes the data to be written (e.g., to configure an IAD or to direct the IAD to operate). For example, the target may be a robotic device, and the data request corresponds to an intent to configure a setting of the robotic device. In such an example, the data request would include the configuration to be established.

The connection broker receives data requests from the data access services via the stateless connections the connection broker maintains. Based on the target in a data request received from a given data access service, the connection broker establishes a stateful connection to the corresponding IAD. The requested data can then be acquired via the connection broker along the established stateful connection and returned, via the connection broker along one of the stateless connections, to the data access service that originated the data request.

The connection broker may analyze the request, connection, and data response associated with a data request to identify concurrent data requests seeking data from the same target. The connection broker is capable of utilizing a single stateful connection to the target of the concurrent data requests. The connection broker is further capable of identifying where concurrent data requests not only target the same IAD, but also request the same data from that IAD. In such cases, the connection broker establishes a single connection to the concurrently targeted IAD and acquires a single instance of the concurrently requested data and returns copies of the data to reduce overhead.

The connection broker evaluates the stateful connections to IADs to determine where any of the stateful connections are beyond a capacity threshold. In response to determining that an established stateful connection to a given IAD is beyond the capacity threshold, the connection broker establishes another connection to the given IAD. The capacity threshold to a high priority workload, a high priority application, a high priority customer, or some other association. The capacity threshold for a high priority data request is a dedicated connection.

In some embodiments, the connection broker identifies concurrent data requests seeking data from the same target. In such cases, the connection broker is capable of utilizing a single stateful connection to the target of the concurrent data requests. The single stateful connection facilitates communication between the data access services associated with each of the concurrent data requests and the target of the concurrent data requests. To identify scenarios in which a single stateful connection can be leveraged for multiple concurrent data requests, a connection manager of the connection broker maintains and queries a request index. The request index includes information corresponding to data requests received at the connection broker, such as the target of a data request, data to be submitted in association with the data request, and the connection required to facilitate the data request. The connection manager evaluates which connections exist and which connects are needed for data requests and concurrent data requests. Based on the information, the connection manager establishes connections, directs other elements of the connection broker to utilize a single stateful connection for multiple data requests, and in some cases, disconnects stateful connections.

In some embodiments, the connection broker is configured to identify where concurrent data requests not only target the same IAD, but also request the same data from that IAD. In such cases, the connection broker establishes a single connection to the concurrently targeted IAD and acquires a single instance of the concurrently requested data. The single instance of the requested data can then be transmitted to each of the data access services corresponding to the concurrent requests.

In some embodiments, the connection broker evaluates the stateful connections to IADs to determine where any of the stateful connections are beyond a capacity threshold. In response to determining that an established stateful connection to a given IAD is beyond the capacity threshold, the connection broker establishes another connection to the given IAD. In some embodiments, the capacity threshold corresponds to a priority of the data request received. Some data requests are high priority because of their association with a high priority workload, a high priority application, a high priority customer, or some other association.

In certain embodiments, the capacity threshold for a high priority data request is a dedicated connection. In other words, data requests associated with a given high priority workload, high priority application, high priority customer, or other high priority association are given a dedicated connection to a target IAD. The dedicated connection is at capacity by virtue of its exclusivity, meaning that any additional connection to the target IAD in question would be beyond the capacity threshold and would result in the establishment of an additional connection to the IAD.

In some embodiments, the COS is hosted on a distributed data storage system that has multiple nodes. In those cases, the connection broker is coupled with the data access services hosted on each of the nodes, meaning the connection broker effectively spans each of the multiple nodes. In certain embodiments, the connection broker is capable of identifying that one of the multiple nodes is failing. In response to the node failure, the connection establishes new stateful connections from a different node of the distributed data storage system in order to replace a connection to an IAD that was eliminated as a result of the node failure.

In some embodiments, the IADs include storage media, industrial controllers, automation devices, or a combination of those elements. In certain embodiments, the data requests include requests to read data. In further embodiments, the data requests include requests to submit data. Where the data requests include requests to submit data, the data request further include the data to be submitted. The data to be submitted may be a write request, a configuration request, or an instruction request. In those cases, the data to be submitted that is included in each data request is the data to be written, the configuration to be implemented, or the instruction to be carried out, respectively.

In some embodiments, the connection broker is configured to determine when no current data request requires a given stateful connection. In response, the connection broker may disconnect the stateful connection.

In some embodiments, the connection broker includes a number of configurable containers. The configurable containers each have a container type and are capable of storing multiple data requests. The container type may be a device-specific container, a device-type-specific container, a data-type-specific container, a workload-specific container, or a combination of those options. The data requests stored in each of the configurable containers corresponds to the container type of the configurable container. For example, a workload-specific container may be configured to receive only data requests that correspond to a particular workload.

Beneficially, the concepts disclosed herein allow a COS utilizing proxy pods techniques for central IAD management to effectively and efficiently scale and load-balance connection services to those proxy pods. As a result, COSs utilizing proxy pods are able to scale and balance COS communication services for the IADs, substantially improving the ability to dynamically manage COS communication resources while continuing to satisfy the fault tolerance generally required for COSs communicating with IADs. This beneficially improves the ability to centrally manage IADs as COS resources, particularly in high performance communication scenarios. Additionally, the same stateful connection can be efficiently used for various data access services without having to re-establish the stateful connection for each new data access service. Furthermore, not only does the disclosure support dynamic connection of data access services to IADs, but it also supports the ability to curate which data requests are handled by which connections. Beneficially, this allows a COS utilizing proxy pods techniques for central IAD management to prioritize certain data requests or groups of data requests over other data requests. This also supports the ability of a COS utilizing proxy pods techniques for central IAD management to manage connection capacity thresholds for stateful connection, facilitating efficient allocation of COS communication resources with respect to prioritized data requests.

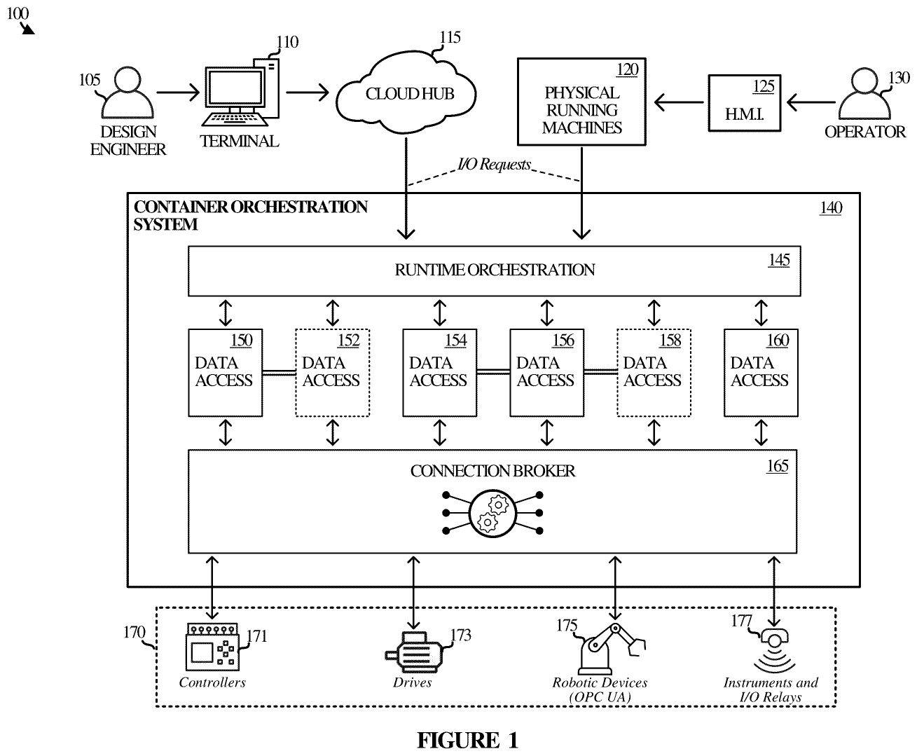

Now turning to the figures, FIG. 1 illustrates operating environment 100 in accordance with some embodiments of the present technology. Operating environment 100 includes design engineer 105, terminal 110, cloud hub 115, physical running machines 120, HMI 125, operator 130, container orchestration system 140, hereinafter represented by COS 140, and devices 170. Devices 170 includes controllers 171, drives 173, robotic devices 175, and instruments and I/O relays 177. COS 140 further includes runtime orchestration 145, data access 150, data access 152, data access 154, data access 156, data access 158, data access 160, and connection broker 165.

Operating environment 100 is generally representative of an environment in which COS 140 may operate by receiving I/O requests and by interfacing with industrial devices (e.g., devices 170). Operating environment 100 may be an industrial environment, a commercial environment, or any other environment in which industrial automation devices operate. For example, operating environment 100 may be an industrial production facility where robotic autonomous devices carry out processes to facilitate production.

Design engineer 105 is generally representative of a user or administrator that interacts with COS 140 in operating environment 100. Design engineer 105 interacts with terminal 110 to engage with COS 140 via cloud hub 115. Terminal 110 is generally representative of a computing system sufficient to receive inputs from design engineer 105 and to transmit communications to cloud hub 115, of which computing system 605 is an example. Terminal 110 may be a local computing device or a distributed computing device. Design engineer communicates with terminal 110 via an interface of terminal 110. Terminal 110 is communicatively coupled with cloud hub 115. Cloud hub 115 is generally representative of a cloud-native application or process that facilitates communication between terminal 110 and COS 140. For example, cloud hub 115 could be FactoryTalk Design Hub offered by ROCKWELL AUTOMATION®. Cloud hub 115 is communicatively coupled with COS 140. Design engineer 105 submits I/O requests to COS 140 via terminal 110 and cloud hub 115.

Operator 130 is generally representative of a user or administrator that interacts with COS 140 on the premises of operating environment 100. Operator 130 interacts with terminal 110 and HMI 125 to engage with COS 140 via physical running machines 120. HMI 125 is generally representative of a human machine interface for communicating with a computing device, such as computing system 605, in operating environment 100. Physical running machines 120 is generally representative of a local computing device sufficient to communicate with HMI 125 and COS 140, respectively. For example, physical running machines 120 could be a server in operating environment 100. Operator 130 submits I/O requests to COS 140 via HMI 125 and physical running machines 120.

In some cases, design engineer 105 submits configurations to COS 140 via terminal 110 and cloud hub 115. In such cases, the configurations submitted to COS 140 by design engineer 105 dictate the operational characteristics of COS 140. In some other cases, design engineer 105 and operator 130 may not directly submit I/O requests to terminal 110 and HMI 125, respectively, but rather design engineer 105 and operator 130 may submit communications that cause one or more of terminal 110, cloud hub 115, HMI 125, or physical running machines 120 to generate an I/O request.

COS 140 is generally representative of a container orchestration system. COS 140 processes containerized workloads submitted via cloud hub 115 and physical running machines 120. For example, COS 140 may be a KUBERNETES® system, a RED HAT® OPENSHIFT® system, an APACHE® MESOS® system, an AMAZON® Elastic Container Service system, an AZURE® Service Fabric system, or any other container orchestration system. COS 140 is configured to receive I/O requests and to process the I/O requests. Processing the I/O requests generally includes generating data requests for each of the I/O requests, establishing stateful connections to devices 170, and facilitating communication to and from each of devices 170. In some instances, data is submitted to devices 170, such as configuration data or operating instructions. In some instances, data is retrieved from devices 170, such as performance history data or current configuration data.

Devices 170 is each generally representative of industrial automation devices in operation environment 100, of which controllers 171, drives 173, robotic devices 175, and instruments and I/O relays 177 are non-limiting examples. Devices 170 may include any industrial automation devices and instrumentation. For example, devices 170 may include any control assets that produce data, such as I/O devices, instrumentation, logic controllers, drives, motors, numerical control machines, industrial computing devices, sensing equipment, and the like. Each of devices 170 receive data requests via connection broker 165. Each of devices 170 may receive data requests and may directly respond to the data requests. In some cases, each of devices 170 are further connected to additional industrial automation devices. In such cases, each of devices 170 may receive data requests and query an additional industrial automation device to acquire the relevant data to be returned. Where the I/O requests include write requests, each of devices 170 may receive the data to be submitted. In some cases, each of devices 170 may receive the data to be submitted but each may relay the data to an additional industrial automation device for submission.

Runtime orchestration 145 is generally representative of software, hardware, or firmware configured to receive I/O requests and to organize them with respect to each of data access 150, data access 152, data access 154, data access 156, data access 158, and data access 160. Runtime orchestration 145 is further configured to receive data responses from each of data access 150, data access 152, data access 154, data access 156, data access 158, and data access 160, and in response, to coordinate the transmission of the data responses to cloud hub 115 and to physical running machines 120. In some cases, runtime orchestration 145 is coupled with fewer or additional sources of I/O requests, and fewer or additional data access service instances.

Data access 150, data access 152, data access 154, data access 156, data access 158, and data access 160 are each generally representative of data access service pods which are configured to receive I/O requests and to generate data requests based on the I/O requests. Each of data access 150, data access 152, data access 154, data access 156, data access 158, and data access 160 may be associated with a stateless data access service. In various examples, COS 140 may include any number of data access service instances. In some cases, data access service pods receive application requests on which the generation of data requests is then based. Each of data access 150, data access 152, data access 154, data access 156, data access 158, and data access 160 are configurable such that they may receive I/O requests that correspond to data access service type. Each of data access 150, data access 152, data access 154, data access 156, data access 158, and data access 160 may be grouped together with another one or more of data access 150, data access 152, data access 154, data access 156, data access 158, and data access 160. As illustrated in operation environment 100, data access 150 and data access 152, and similarly data access 154, data access 156, and data access 158 are grouped, respectively. The groupings correspond to the types of I/O requests or application requests received. The groupings may further correspond to a particular workload, a particular application, and particular data type, a particular customer, and the like. Where a given data access instance is configured to receive a certain type of I/O request or application request, runtime orchestration 145 relays the I/O requests or application requests corresponding to the type to the given data access instance.

The number of data access instances, of which there are six in COS 140, may be dynamically increased or decreased. Note that as illustrated in FIG. 1, data access 152 and data access 158 are outlined with a dashed line, which can be interpreted to indicate a recent instantiation. For example, where data access 150 is dedicated to processing I/O requests for a given workload, which suddenly increases in magnitude. To account for the increased volume of I/O requests, data access 152 is spun up and grouped with data access 150. Similarly, data access 158 is spun up and grouped with data access 154 and data access 156. In an alternative view, the dashed line outline of data access 152 and data access 158 can be interpreted to indicate a recent elimination. As an example under such an alternative view, the workload corresponding to the grouping of data access 150 and data access 152 suddenly decreases in magnitude. The decreased volume of I/O requests can now be sufficiently managed by data access 150. To efficiently utilize the resources of COS 140, the now unnecessary instance, data access 152, is eliminated from COS 140.

Connection broker 165 is software, firmware, or hardware configured to receive data requests from data access 150, data access 152, data access 154, data access 156, data access 158, and data access 160, to establish stateful connections to devices 170, and to facilitate communication between data access 150, data access 152, data access 154, data access 156, data access 158, and data access 160 and devices 170. In particular, connection broker 165 is configured to maintain stateless connections to data access 150, data access 152, data access 154, data access 156, data access 158, and data access 16 and to establish and preserve stateful connections between connection broker 165 and devices 170. Connection broker 165 receives data requests via the stateless connections, communicates with devices 170 via the stateful connections, and returns a data response via the stateless connections.

In some embodiments, connection broker 165 is configured to evaluate a request, the target of a request, and a data response associated with the request. Based on the evaluation, connection broker may utilize a single stateful connection to one of controllers 171, drives 173, or robotic devices 175 to facilitate communication from more than one of data access 150, data access 152, data access 154, data access 156, data access 158, and data access 160. Utilizing a single stateful connection for more than one data request reduces the overhead necessary to process the more than one data request. In some cases, based on the evaluation, connection broker 165 determines that more than one of data access 150, data access 152, data access 154, data access 156, data access 158, and data access 160 are concurrently requesting the same data from the same one of controllers 171, drives 173, or robotic devices 175. In such a case, connection broker 165 retrieves the data response once and returns the data response to each of the concurrent requesters. In some cases, the data response is stored in a response buffer to facilitate sending the data response to multiple of data access 150, data access 152, data access 154, data access 156, data access 158, or data access 160.

In some embodiments, connection broker 165 determines when a given stateful connection is beyond a capacity threshold. This may occur because the volume of data requests utilizing the given stateful connection have exceeded a predetermined limit. The predetermined limit can be selected based on operation efficiency for COS 140, on load balancing in COS 140, or with regard to a corresponding data access priority, workload priority, customer priority, or any other characteristic on which determining the limit for communication volume on a stateful connection can be based. In some cases, the capacity threshold of a stateful connection is configured such that the stateful connection acts as a dedicated communication channel. In such a case, the stateful connection functions as a dedicated communication channel, and any additional communication along that stateful connection would be beyond the relevant capacity threshold. In other words, processing any additional data requests beyond the data requests associated with the dedicated connection requires the establishment of another stateful connection.

In an example operation, both design engineer 105 and operator 130 submit I/O requests to COS 140. Design engineer 105 submits a request to submit data to COS 140 via terminal 110 and cloud hub 115. Operator 130 submits a request to read data to COS 140 via HMI 125 and physical running machines 120. Both the request to submit data and the request to read data include information detailing the nature of the request and the intended target of the request. The target of the request to submit data is robotic devices 175, and the target of the request to read data is drives 173. The request to submit data submitted by design engineer 105 also includes the data to be submitted, which in the ongoing example, is a configuration setting of robotic devices 175.

Runtime orchestration 145 of COS 140 receives the request to submit data and the request to read data. The request to submit data is transmitted to data access 150, while the request to read data is transmitted to data access 154. Data access 150 receives the request to submit data and generates a data request corresponding to the request to submit data. Data access 154 receives the request to read data and generates a data request corresponding to the request to read data.

Connection broker 165, having maintained stateless connections to both data access 150 and data access 154, identifies the data requests associated with the request to submit data and the request to read data, respectively, and further identifies the target of both the request to submit data and the request to read data. Connection broker 165 determines at this time that neither the request to submit data or the request to read data, or any other I/O request of COS 140, correspond to concurrent data requests concurrent for the same data or having the same target. As a result, in the current example, the data requests associated with the request to submit data and the request to read data cannot be facilitated using a single stateful connection and also cannot be satisfied using copies of a single data response.

Connection broker 165, having evaluated the target of the data requests corresponding to the request to submit data and the request to read data, establishes a stateful connection to drives 173 and to robotic devices 175. Connection broker 165 then facilitates communication between data access 150 and robotic devices 175, and between data access 154 and drives 173. To facilitate communication between data access 150 and robotic devices 175, connection broker 165 transmits request to submit data and the data to be submitted to robotic devices 175. Transmitting messages to industrial devices, such as robotic devices 175 or drives 173, from connection broker 165 may be accomplished by connection broker 165 sending a copy of the message or an indication of the message.

With respect to drives 173, connection broker 165 transmits the data request corresponding to the request to read data to drives 173 via the established stateful connection to drives 173. Drives 173, in response, provide the requested data response to connection broker 165. Connection broker 165 then returns the requested data response to data access 154. Runtime orchestration 145 receives the requested data response from data access 154, which is then communicated back to operator 130 via physical running machines 120 and HMI 125.

With respect to robotic devices 175, connection broker 165 transmits the data request corresponding to the request to submit data to robotic devices 175 via the established stateful connection to robotic devices 175. Robotic devices 175, in response, implement the configuration included in the data request. Here, robotic devices 175 further provide a configuration response to connection broker 165. Connection broker 165 then returns the configuration response to data access 150. Runtime orchestration 145 receives the configuration response from data access 150, which is then communicated back to design engineer 105 via cloud hub 115 and terminal 110. In some other examples, a request to submit data that includes a configuration may not result in a data response from the target being configured.

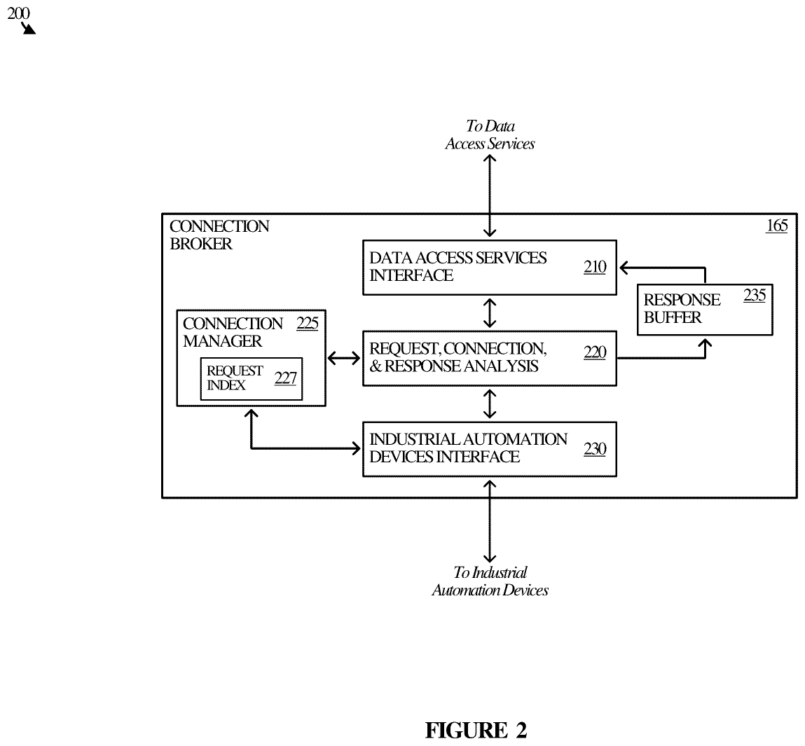

FIG. 2 illustrates a connection broker in further detail, hereinafter represented by broker 200, in accordance with some embodiments of the present technology. Broker 200 includes connection broker 165 of FIG. 1 and may be considered with regard to the other elements of FIG. 1. Connection broker 165 is described in detail in the text associated with FIG. 1. As illustrated in broker 200, connection broker 165 further includes data access services interface 210, request, connection, and response analysis 220, connection manager 225, industrial automation devices interface 230, and response buffer 235. Connection manager 225 further includes request index 227.

Data access services interface 210 is generally representative of software, hardware, or firmware that facilitates communication and data transmission between data access services of COS 140 and connection broker 165. Data access services interface 210 is configured to maintain stateless connections with data access services of COS 140, such as data access 150, data access 152, data access 154, data access 156, data access 158, and data access 160. Data access services interface 210 is further configured to scale up or scale down the connections maintained to the data access services in response to the volume of data access services scaling up or scaling down. In some embodiments, connection manager 225 directs data access services interface 210 to scale up or scale down connections to data access services of COS 140. Data access services interface 210 is also configured to receive data requests from the data access services via the stateless connections and to return data responses to the data access services via the stateless connections. In some scenarios, data access services interface 210 receives a data response from response buffer 235 and returns the data response received from response buffer 235 to a data access service of COS 140.

Request, connection, and response analysis 220 is generally representative of software, hardware, or firmware that evaluates data requests, identifies targets of the data requests, identifies connections necessary for the targets of the data requests, and identifies the desired data response where relevant. Based on the evaluation and identification performed by request, connection, and response analysis 220, concurrent requests to the same target and concurrent requests to the same target for the same data can be identified. Where two or more concurrent data requests identify the same target, request, connection, and response analysis 220 directs industrial automation device interface 230 to utilize a single stateful connection for each of the two or more concurrent data requests. In some embodiments, request, connection, and response analysis 220 directs industrial automation device interface 230 to utilize the single stateful connection for each of the two or more concurrent data requests via connection manager 225. Where two or more concurrent data requests have the same target and request the same data, request, connection, and response analysis 220 directs industrial automation device interface 230 to utilize a single stateful connection and to acquire the concurrently requested data response a single time. The single instance of the data response is then returned to each of the corresponding data access services via data access services interface 210. In some cases, the single instance of the data response is held in response buffer 235 in order to facilitate transmitting the single instance to multiple data access services.

Connection manager 225 is generally representative of software, hardware, or firmware that evaluates stateless connections to data access services of COS 140 and stateful connections to industrial automation devices such as devices 170. In some cases, connection manager 225 receives information about a data request from request, connection, and response analysis 220, including which connection is necessary with regard to the target of the data request. In response, request, connection, and response analysis 220 determines whether or not the required stateless connection has been established. Connection manager 225 maintains request index 227 to track information for each incoming data request and the established connections. Request index 227 is generally representative of a data structure used to store and query information relating to data requests received, the targets of those data requests, and the necessary connections for those data requests. Connection manager 225 may query request index 227 as part of establishing stateful connections to industrial automation devices. Request index 227 may be queried in response to connection manager 225 receiving a data request, or may otherwise be referenced by connection manager 225, or else by request, connection, and response analysis 220, on a per-request basis. Request, connection, and response analysis 220 receives a data request and leverages connection manager 225 to facilitate communication to the targeted industrial automation device. Request, connection, and response analysis 220 delivers the data request to connection manager 225 along with information that describes the request, the target of the data request, and the connection necessary for the data request. Connection manager 225 populates request index 227 with the information and determines what must be done to facilitate the data request. In some cases, connection manager 225 determines by querying request index 227 that the data request is concurrent with an existing data request already in the process of acquiring the same data response from the same industrial automation device. In such a scenario, connection manager 225 directs industrial automation devices interface 230 to utilize the existing stateful connection to the industrial automation device as relevant to the data request, allowing the data request to be communicated without having established a new stateful connection.

In some cases, request, connection, and response analysis 220 not only determines whether or not the required stateless connection has been established, but also evaluates if, where the connection has already been established, using the stateful connection for the data request at issue would cause the state connection to be beyond a predetermined capacity threshold. Where the stateful connection would be beyond a predetermined capacity threshold as a result of processing the data request, connection manager 225 directs from industrial automation devices interface 230 to establish an additional stateful connection to the target.

Connection manager 225 is also configured to direct data access services interface 210 to scale up or to scale down stateless connections to data access services in response to an indication that the data access services of COS 140 have been scaled up or scaled down. Connection manager 225 is further configured to direct industrial automation devices interface 230 to establish stateful connections to industrial automation devices. In some cases, connection manager 225 is configured to identify a new industrial automation device, and in response, to establish a stateful connection to the new industrial automation device.

Industrial automation devices interface 230 is generally representative of software, hardware, or firmware that facilitates communication and data transmission between industrial automation devices and connection broker 165. In particular, industrial automation devices interface 230 is configured to establish and preserve stateful connections to industrial automation devices. In some cases, preserving the stateful connections includes regularly transmitting acknowledgements from industrial automation devices interface 230 along the stateful connection to the industrial automation device.

Response buffer 235 is software, hardware, or firmware for the storing of data responses. Response buffer 235 may hold any number of different data responses, and when directed by request, connection, and response analysis 220, response buffer is configured to provide one or more of the data responses to data access services interface 210.

In an example operation, a data access service of COS 140 receives an I/O request generates a data request based on the I/O request. The data request is received at data access services interface 210 of connection broker 165. Data access services interface 210 delivers the data request to request, connection, and response analysis 220 for evaluation. Request, connection, and response analysis 220 identifies the target of the data request, the connection necessary for communicating with the target, and the desired data response. Request, connection, and response analysis 220 sends an indication of the necessary target to connection manager 225. Connection manager 225 determines that no sufficient stateful connection is established, and in response, directs industrial automation devices interface 230 to establish a stateful connection to the target. The data request, or in some cases an indication of the data request, is transmitted from industrial automation devices interface 230 to the target of the data request along the established stateful connection. Industrial automation devices interface 230 then receives a data response, which is returned back, via data access services interface 210, to the data access service of COS 140 having originated the data request.

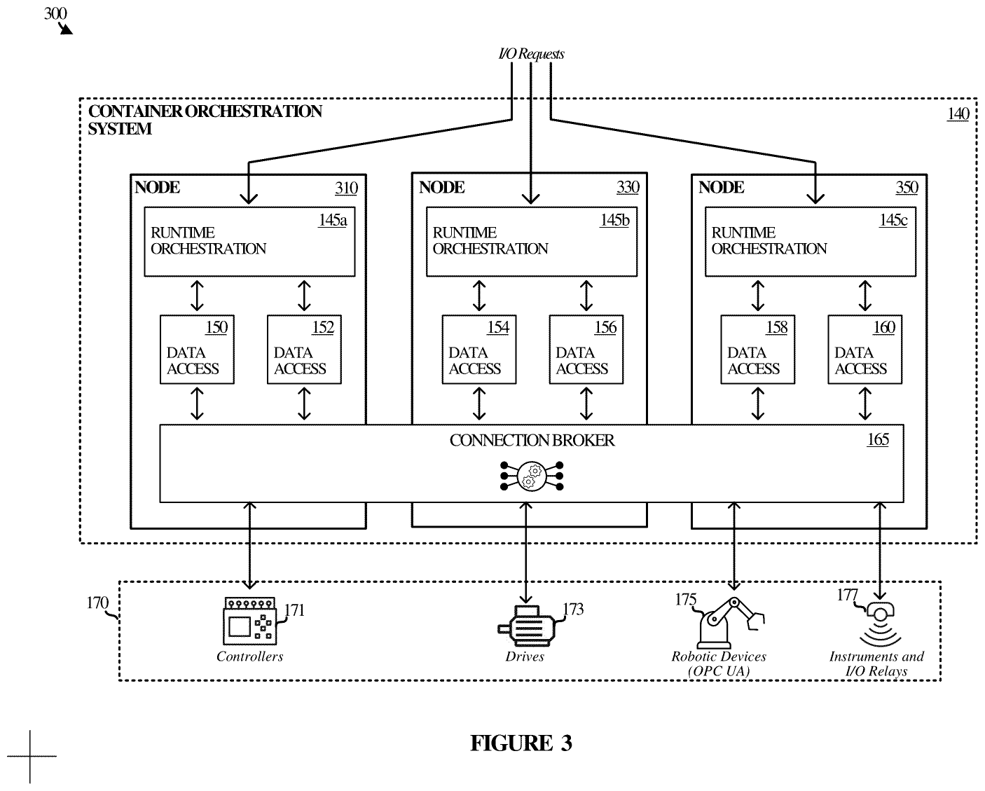

FIG. 3 illustrates another operating environment, hereinafter represented by environment 300, in accordance with some embodiments of the present technology. Environment 300 includes COS 140 and devices 170. As illustrated in environment 300, COS 140 further includes node 310, node 330, and node 350. Node 310 further includes runtime orchestration 145a, data access 150, and data access 152. Node 330 further includes runtime orchestration 145b, data access 154, and data access 156. Node 350 further includes runtime orchestration 145c, data access 158, and data access 160. Node 310, node 330, and node 350 further include a single instance of connection broker 165 that spans each of node 310, node 330, and node 350.

COS 140, devices 170, data access 150, data access 152, data access 154, data access 156, data access 158, data access 160, and connection broker 165, each of FIG. 1, are generally described in detail in the text associated with FIG. 1.

COS 140 as illustrated in environment 300 is hosted on a distributed computing environment. In such an example, instances of the elements of COS 140 are hosted in individual computing environments, here being node 310, node 330, and node 350. Each of node 3310, node 330, and node 350 may themselves be hosted on a local computing device or a distributed computing device, of which computing system 605 is generally representative. In a distributed computing system, additional nodes can be used to mitigate the risk associated with node failure. Having multiple nodes allows for node failover, a process in which connections or processes of a failing node are automatically transferred over to a properly functioning node such that the connections and processes may continue uninterrupted.

Node 310, node 330, and node 350 are generally representative of physical nodes in a distributed computing system. As mentioned in the preceding paragraphs, having multiple nodes increases a distributed computing system's resilience to the problems caused by node failure. Without multiple nodes, a computing system failure could have catastrophic results with respect to ongoing processes that the computing system was managing at the time of the failure.

Runtime orchestration 145a, runtime orchestration 145b, and runtime orchestration 145c, are each instances of runtime orchestration 145 of FIG. 1. Each instance of runtime orchestration 145 of FIG. 3 is substantially the same as runtime orchestration 145 as described in FIG. 1. Each of runtime orchestration 145a, runtime orchestration 145b, and runtime orchestration 145c are described in further detail by reference to the associated text for runtime orchestration 145 in FIG. 1.

Data access 150, data access 152, data access 154, data access 156, data access 158, and data access 160 of FIG. 3 are each substantially the same as data access 150, data access 152, data access 154, data access 156, data access 158, and data access 160 of FIG. 1, and are described in further detail with reference to the associated text in FIG. 1.

Connection broker 165 of FIG. 3 is substantially the same as connection broker 165 of FIG. 1 and connection broker 165 of FIG. 2 and is described by reference to the text associated with the preceding figures. Here, connection broker 165 is shown to be shared by each of node 310, node 330, and node 350. While, in a distributed computing system, instances of connection broker 165 are present in each of node 310, node 330, and node 350, the connection broker pictured in FIG. 3 may be considered as a single instance of connection broker 165 that spans each of node 310, node 330, and node 350. In a distributed computing system, connection broker 165 is further configured to determine when one or more of node 310, node 330, or node 350 are failing. In response to determining that node failure is occurring, connection broker 165 identifies one or more stateful connections associated with the node determined to be failing, and in response, establishes new stateful connections to account for the stateful connections that will be eliminated from COS 140 as a result of the node failure.

In an example operation, each of node 310, node 330, and node 350 receive an I/O request. Data access 150, data access 154, and data access 158 receive the I/O request of node 310, node 330, and node 350, respectively. Each of data access 150, data access 154, and data access 158 process the respective I/O requests to generate data requests. The data requests, or an indication thereof, are sent by each of data access 150, data access 154, and data access 158 to connection broker 165. Connection broker 165 leverages industrial automation network router 370 to establish and maintain the stateful connections to devices 170 with respect to each of node 310, node 330, and node 350.

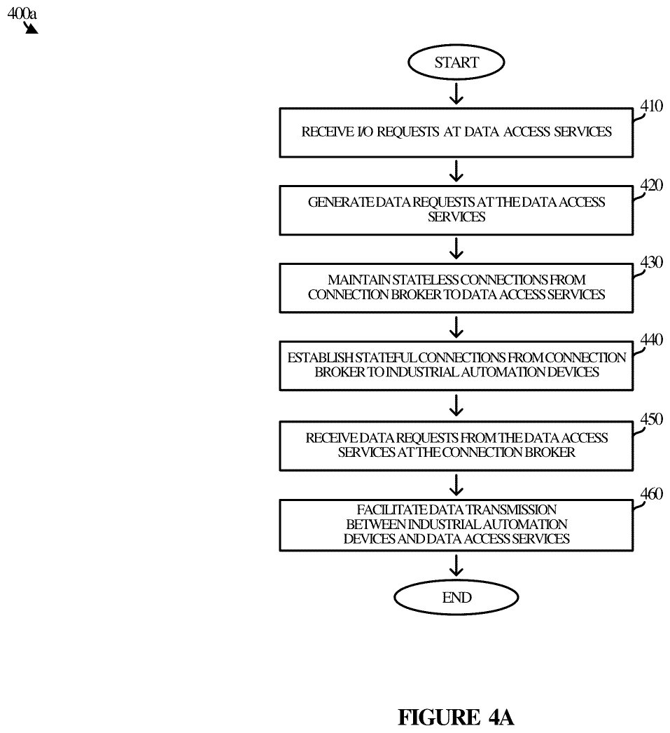

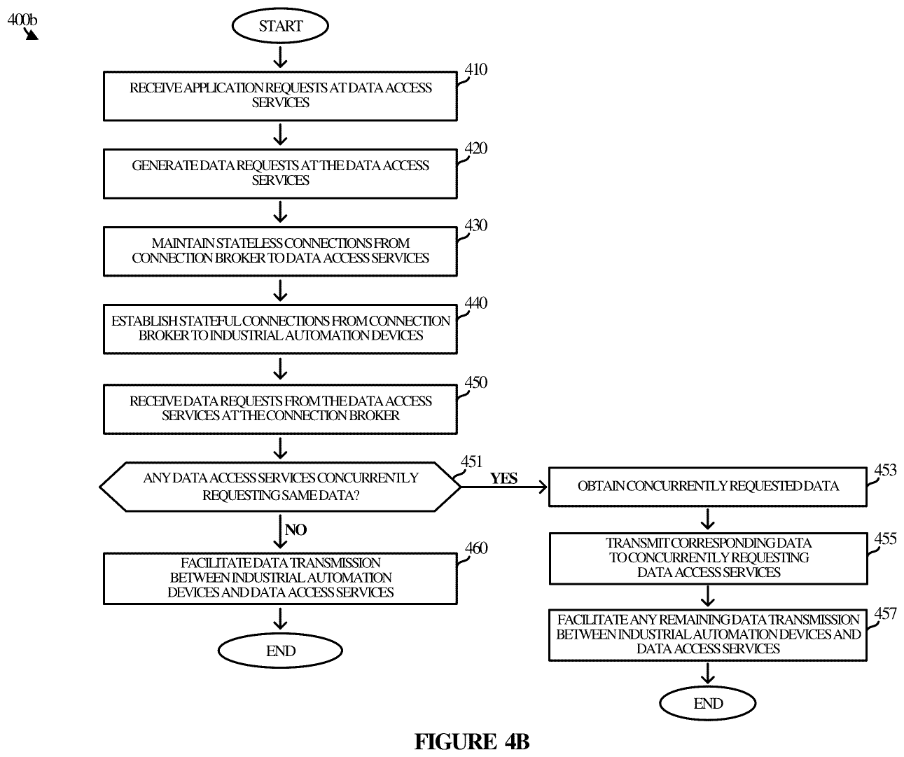

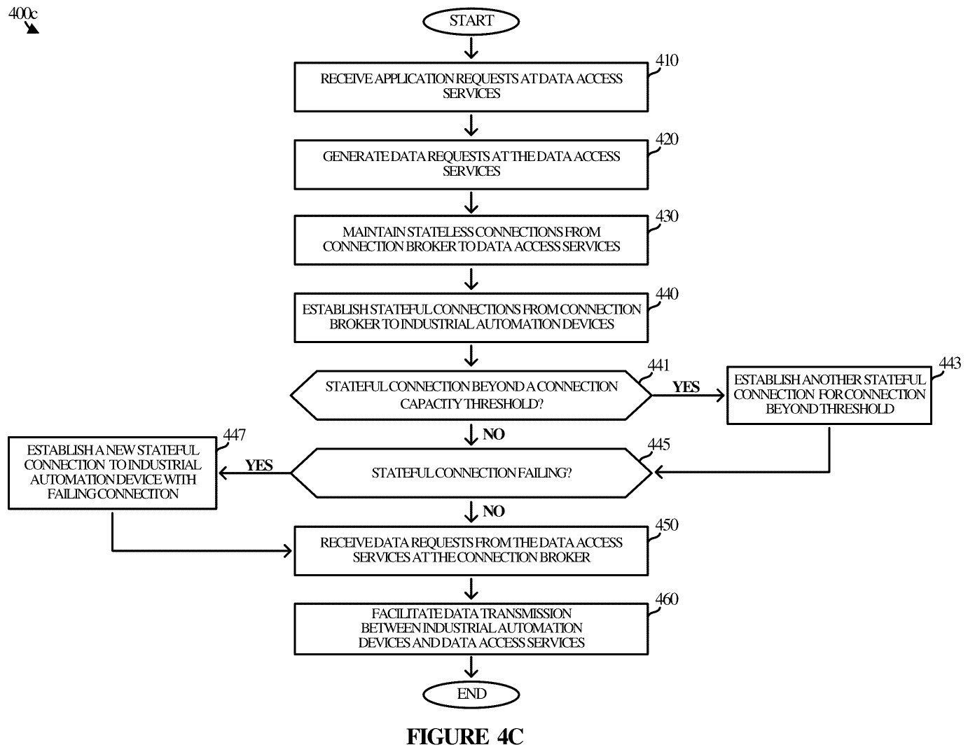

FIG. 4A illustrates method 400a of orchestrating containerized workloads in accordance with some embodiments of the present technology. The steps of method 400a are referenced parenthetically in the paragraphs that follow and may be carried out in the context of the systems and elements of operation environment 100 of FIG. 1, broker 200 of FIG. 2, and environment 300 of FIG. 3, respectively.

To begin, data access services (e.g., data access 150, data access 152, etc.) of a container orchestration system (e.g., COS 140) receive I/O requests (step 410). The I/O requests may include requests to write data and requests to read data. Each of the I/O requests has a target, which in many cases is an industrial automation device, such as drives 173, for example. Based on the I/O requests, the data access services generate data requests for each of the I/O requests (step 420). The data access services may receive requests based on predetermined rules. For example, a given workload or application may correspond to a particular data access service. In another example, a particular type of I/O request may be handled by a particular data access service. A connection broker (e.g., connection broker 165) maintains stateless connections with each of the data access services (step 430) and establishes stateful connections to industrial automation devices (e.g., devices 170) (step 440). The connection broker receives each of the data requests from the data access services (step 450) and facilitates data transmission between the data access services and the industrial automation devices (step 460). In some cases, the connection broker receives the data requests, and in response to receiving the data requests, identifies the stateful connections associated with the targets of the data requests. The connection broker then establishes the identified stateful connections and facilitates communication with the industrial automation devices relevant to the data requests.

FIG. 4B illustrates another method of orchestrating containerized workloads, hereinafter represented by method 400b, in accordance with some embodiments of the present technology. The steps of method 400b are referenced parenthetically in the paragraphs that follow and may be carried out in the context of the systems and elements of operation environment 100 of FIG. 1, broker 200 of FIG. 2, and environment 300 of FIG. 3, respectively. Further, step 410, step 420, step 430, step 440, step 450, and step 460 of method 400b are substantially the same as step 410, step 420, step 430, step 440, step 450, and step 460 of method 400a, and are described in detail in the associated text to FIG. 4A.

Method 400b further includes conditional step 451. The connection broker evaluates the data requests received at step 450 and determines if any two or more of the data access services of the container orchestration system are concurrently attempting to communicate with the same industrial automation device in order to acquire the same data. To detect concurrent requests, the connection broker leverages a connection manager to identify established connections and to establish new connections where needed. An example of the connection manager is given by connection manager 225 of FIG. 2. The connection manager maintains and references a request index (e.g., request index 227 of FIG. 2) with information associated with the data requests, including the targets of data requests, the connection required for the data request, and in some cases the data to be written in association with the data request. The connection manager detects concurrent data requests based on the information contained in the request index. Where no concurrent data requests target the same industrial automation device for the same data (step 451), method 400b proceeds to step 460 in the same fashion as method 400a. Where, however, the connection broker does identify concurrent data requests that target the same industrial automation device and seek the same data (step 451), the connection broker establishes a single stateful connection to that industrial automation device and collects the data response associated with the concurrently requested data (step 453). The connection broker then transmits the data response to each of the data access services corresponding to the concurrent data requests (step 455). Having already processed the concurrent data requests, the connection broker then facilitates any communication relating to data requests not yet processed (step 457).

FIG. 4C illustrates another method of orchestrating containerized workloads, hereinafter represented by method 400c, in accordance with some embodiments of the present technology. The steps of method 400c are referenced parenthetically in the paragraphs that follow and may be carried out in the context of the systems and elements of operation environment 100 of FIG. 1, broker 200 of FIG. 2, and environment 300 of FIG. 3, respectively. Further, step 410, step 420, step 430, step 440, step 450, and step 460 of method 400c are substantially the same as step 410, step 420, step 430, step 440, step 450, and step 460 of method 400a, and are described in detail in the associated text to FIG. 4A.

Method 400c further includes conditional step 441 and conditional step 445. Having established the stateful connections at step 440, the connection broker determines if utilizing a given stateful connection to transmit a data request will result in the stateful connection being beyond a predetermined capacity threshold (step 441). To evaluate the capacity and usage of a given stateful connection, the connection broker leverages a connection manager and request index (e.g., connection manager 225 and request index of 227, each of FIG. 2, respectively). Connection capacities can be entered to the request index by an administrator and subsequently queried by the connection manager in order to determine where a particular connection is at capacity or can otherwise accommodate another data request.

Where utilizing the stateful connection would not result in the stateful connection being beyond the predetermined capacity threshold, method 400b proceeds to conditional step 445. Where, however, utilizing the stateful connection would result in the stateful connection being beyond the predetermined capacity threshold (step 441), the connection broker establishes another stateful connection to the same target as the connection that would be beyond the capacity threshold if utilized (step 443). In either case, method 400c proceeds to step 445.

The connection broker identifies if any of the stateful connections are failing, or else if any nodes of the distributed computing system hosting the container orchestration system are failing (step 445). Determining that a stateful connection is failing may result from an analysis of communications along the stateful connection, while determining that a node is failing may result from information from provided by a host environment of the container orchestration system. Where the connection broker determines that a stateful connection, or else a node, is failing, the connection broker establishes a new stateful connection to account for a failed stateful connection, or for a stateful connection that was eliminated as a result of an associated node's failure (step 447). In either case, method 400c proceeds to step 450.

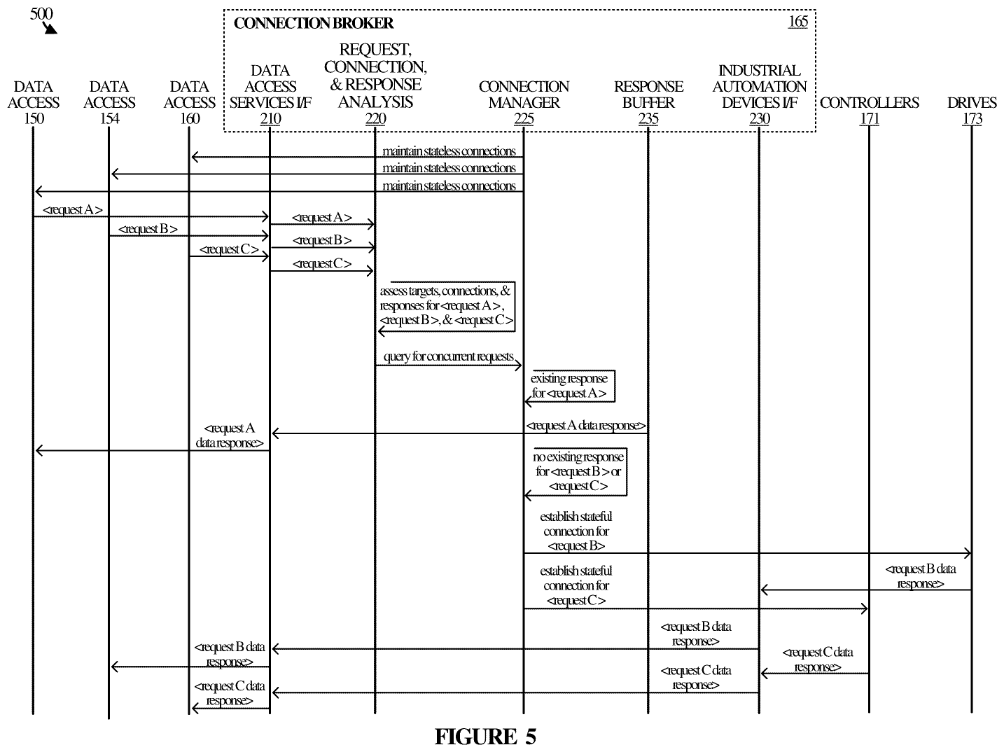

FIG. 5 illustrates software flow diagram 500 in accordance with some embodiments of the present technology. Software flow diagram 500 may be considered with regard to the steps of method 400a, method 400b, and method 400c. Software flow diagram 500 includes data access 150, data access 154, data access 160, connection broker 165, controllers 171, and drives 173. As illustrated in broker 200, connection broker 165 of software flow diagram 500 further includes data access services interface 210, request, connection, and response analysis 220, connection manager 225, industrial automation devices interface 230, response buffer 235. Data access services interface 210, request, connection, and response analysis 220, connection manager 225, industrial automation devices interface 230, response buffer 235, each of FIG. 2, are each described in further detail in the text associated with FIG. 2.

To begin, connection manager 225 of COS 140 maintains stateless connections to each of data access 150, data access 154, and data access 160, respectively. Along each of the respective stateless connections, data access services interface 210 receives data requests from each of data access 150, data access 154, and data access 160. Data access 150 generated request A, data access 154 generated request B, and data access 160 generated request C. Request A, request B, and request C are each received at data access services interface 210 and subsequently delivered to request, connection, and response analysis 220. Request, connection, and response analysis 220 assess each of request A, request B, and request C to evaluate the respective requests and identify the target of the requests and the connections necessary to communicate with the targets of the request. Here, request, connection, and response analysis 220 queries connection manager 225 to determine if the data response associated with any of request A, request B, or request C already exists and is stored in response buffer 235. In some cases, connection manager 225 leverages a request index to determine where an existing connection or existing data response can be leveraged for another data request. An example of a request index is given by request index 227 of FIG. 2. As illustrated in FIG. 5, connection manager 225 determines that response buffer 235 does include a data response that satisfies request A. The data response associated with request A, request A data response, is sent from response buffer 235 to data access 150 via data access services interface 210. Connection manager 225 determines, by referencing the request index, that no sufficient data response for request B and request C are identified in response buffer 235. The identified target of request B is drives 173, while the identified target of request C is controllers 171.

Connection manager 225, having received request, target, and connection information for request B and request C, establishes stateful connections to controllers 171 and drives 173 to facilitate communication. Via the stateful connection to drives 173, the connection broker facilitates communication to drives 173 and receives back a request B data response from drives 173. Similarly, connection broker 165 facilitates communication to controllers 171 and receives back a request C data response from controllers 171. Request B data response and request C data response are received at industrial automation devices interface 230 of connection broker 165. Data access services interface 210 receives request B data response and request C data response from industrial automation devices interface 230 and relays them to data access 154 and data access 160.

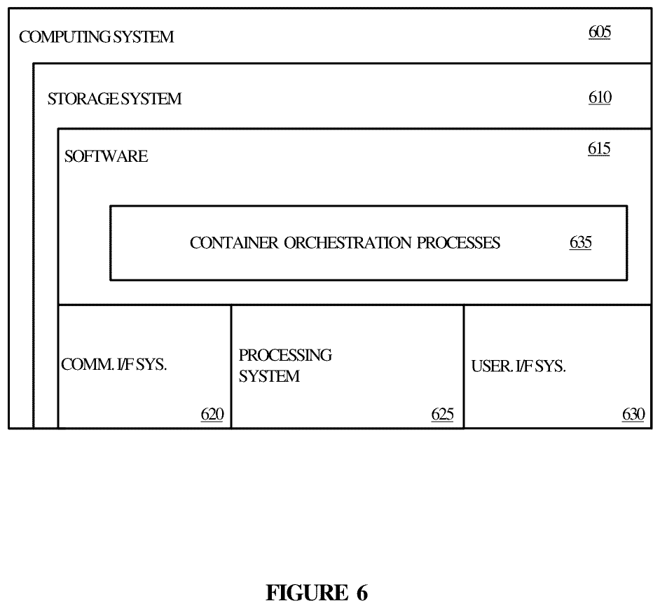

FIG. 6 illustrates computing system 605 used in accordance with some embodiments of the present technology. Computing system 605 is generally representative of a computing device sufficient to execute container orchestration processes 635. In some embodiments, computing system 605 is configured to be a user device, such as terminal 110 of FIG. 1. In some embodiments, computing system 605 is configured as a node in a distributed computing system, such as node 310, node 330, or node 350 of FIG. 3. Where computing system 605 represents a node in a distributed computing system, computing system 605 and each of the other nodes of the distributed computing system may be connected by a variety of communication technologies. Where computing system 605 represents a node in a distributed computing system, computing system 605 may be located on the premises of an industrial environment or may otherwise be located remotely.

Computing system 605 is representative of a computing device sufficient to execute software and communicate with peripherals. Computing system 605 is representative of any system or collection of systems with which the various operational architectures, processes, scenarios, and sequences disclosed herein for implementation of a system for orchestrating containerized workloads may be employed. Computing system 605 may be implemented as a single apparatus, system, or device or may be implemented in a distributed manner as multiple apparatuses, systems, or devices. Computing system 605 includes, but is not limited to, processing system 625, storage system 610, software 615, communication interface system 620, and user interface system 630. Processing system 625 is operatively coupled with storage system 610, communication interface system 620, and user interface system 630. Computing system 605 may be representative of a cloud computing device, distributed computing device, or the like.

Processing system 625 loads and executes software 615 from storage system 610. Software 615 includes and implements container orchestration processes 635. When executed by processing system 625 to provide container orchestration processes 635, software 615 directs processing system 625 to operate as described herein for at least the various processes, operational scenarios, and sequences discussed in the foregoing implementations. Computing system 605 may optionally include additional devices, features, or functionality not discussed for purposes of brevity.

Processing system 625 may include a microprocessor and other circuitry that retrieves and executes software 615 from storage system 610. Processing system 625 may be implemented within a single processing device but may also be distributed across multiple processing devices or sub-systems that cooperate in executing program instructions. Examples of processing system 625 include general purpose central processing units, graphical processing units, application specific processors, and logic devices, as well as any other type of processing device, combinations, or variations thereof.

Storage system 610 may include any computer readable storage media readable by processing system 625 and capable of storing software 615. Storage system 610 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations, storage system 610 may also include computer readable communication media over which at least some of software 615 may be communicated internally or externally. Storage system 610 may be implemented as a single storage device but may also be implemented across multiple storage devices or sub-systems co-located or distributed relative to each other. Storage system 610 may include additional elements, such as a controller capable of communicating with processing system 625 or other systems.

Software 615 (including container orchestration processes 635) may be implemented in program instructions and, when executed by processing system 625, can direct processing system 625 to operate as described with respect to the various operational scenarios, sequences, and processes illustrated herein. For example, software 615 may include program instructions for implementing a connection broker.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 615 may include additional processes, programs, or components, such as operating system software, virtualization software, or other application software. Software 615 may also include firmware or some other form of machine-readable processing instructions executable by processing system 625.

In general, software 615 may, when loaded into processing system 625 and executed, transform a suitable apparatus, system, or device (of which computing system 605 is representative) overall from a general-purpose computing system into a special-purpose computing system customized to provide container orchestration processes 635 as described herein. Indeed, encoding software 615 on storage system 610 may transform the physical structure of storage system 610. The specific transformation of the physical structure may depend on various factors in different implementations of this description. Examples of such factors may include, but are not limited to, the technology used to implement the storage media of storage system 610 and whether the computer-storage media are characterized as primary or secondary storage, as well as other factors.

For example, if the computer readable storage media are implemented as semiconductor-based memory, software 615 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 620 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The media, connections, and devices are well known and need not be discussed at length here.

Communication between computing system 605 and other computing systems (not shown), may occur over a communication network or networks and in accordance with various communication protocols, combinations of protocols, or variations thereof. Non-limiting examples include intranets, internets, the Internet, local area networks, wide area networks, wireless networks, wired networks, virtual networks, software defined networks, data center buses and backplanes, or any other type of network, combination of networks, or variation thereof. The communication networks and protocols are well known and need not be discussed at length here. More generally, computing system 605 may communicate over the communication link used to distribute the software layer across physical compute surfaces. The communication link may be any kind of communication link between compute surfaces such as, but not limited to, physical wired networks and wireless (e.g., cellular) networks.

While some examples provided herein are described in the context of an industrial environment, it should be understood that the systems and methods described herein are not limited to such embodiments and may apply to a variety of other industrial environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A system for orchestrating containerized workloads, the system comprising:
a plurality of data access services configured to:
receive application requests, wherein the application requests correspond to one or more industrial automation devices of a plurality of industrial automation devices that execute industrial automation processes, and
generate data requests based on the application requests, wherein the data requests identify the corresponding one or more industrial automation devices in the respective application request; and
a connection broker configured to:
maintain stateless connections with the plurality of data access services,
establish stateful connections to the plurality of industrial automation devices,
receive the data requests from the plurality of data access services,
for each data request of the data requests:
facilitate data transmission between the corresponding one or more industrial automation devices and a requesting data access service of the plurality of data access services using the respective stateful connections and the respective stateless connections.

2. The system of claim 1, wherein the receiving the data requests from the plurality of data access services further comprises using one of the stateful connections to facilitate the data transmission between the corresponding one or more industrial automation devices and multiple requesting data access services.

3. The system of claim 1, wherein the connection broker is further configured to:
identify, at the connection broker, concurrent requests for a same data requested from a same industrial automation device of the plurality of industrial automation devices;
obtain the same data corresponding to the concurrent requests once; and
transmit the same data corresponding to the concurrent requests to each data access service of the plurality of data access services associated with the concurrent requests.

4. The system of claim 1, wherein:
the connection broker is further configured to determine that one of the stateful connections to one of the plurality of industrial automation devices is beyond a connection capacity threshold; and
the connection broker is further configured to establish, in response to determining that one of the stateful connections to one of the plurality of industrial automation devices is beyond the connection capacity threshold, another stateful connection to the one of the plurality of industrial automation devices.

5. The system of claim 4, wherein:
one of the application requests is a high priority request; and
in response to receiving the high priority request, the connection broker is configured to establish a dedicated connection associated with the high priority request.

6. The system of claim 5, wherein the connection capacity threshold is configured such that the dedicated connection is preserved.

7. The system of claim 1, wherein:
the system is implemented in an environment comprising a distributed data storage system having a plurality of nodes;
the connection broker spans the plurality of nodes; and
maintaining the stateless connections between the connection broker and the plurality of data access services further comprises establishing, at the connection broker, stateless connections to any access services hosted on the plurality of nodes.

8. The system of claim 7, wherein the connection broker is further configured to:
determine that one of the stateful connections between the connection broker and an industrial automation device of the plurality of industrial automation devices is failing; and
in response, establish a new stateful connection between the connection broker and the industrial automation device.

9. The system of claim 1, wherein the plurality of industrial automation devices comprises one or more of each of a storage media, an industrial controller, an automation device, or a combination thereof.

10. The system of claim 1, wherein the application requests comprises a request to read data.

11. The system of claim 1, wherein:
the application requests comprises a request to submit data;
the request to submit data comprises one of a write request, a configuration request, or an instruction request; and
the request to submit data includes the data to be submitted.

12. The system of claim 1, wherein the connection broker is further configured to determine where no current data request requires a given stateful connection, and in response, to disconnect the given stateful connection.

13. The system of claim 1, wherein the connection broker comprises a plurality of containers, wherein each container of the plurality of containers:
has a container type, wherein the container type comprises one of a device-specific container, a device-type-specific container, a data-type-specific container, a workload-specific container, or a combination thereof; and
receives the data requests, wherein the data requests received correspond to the container type.

14. A method for orchestrating containerized workloads, the method comprising:
receiving, at a plurality of data access services, application requests, wherein the application requests correspond to one or more industrial automation devices of a plurality of industrial automation devices that execute industrial automation processes;
generating, at the plurality of data access services, data requests based on the application requests, wherein the data requests identify the corresponding one or more industrial automation devices in the respective application request;
maintaining, by a connection broker, stateless connections between the connection broker and the plurality of data access services;
establishing, by the connection broker, stateful connections to the plurality of industrial automation devices; and
receiving, at the connection broker, the data requests from the plurality of data access services, wherein, the receiving comprises:
for each data request, facilitating, by the connection broker, data transmission between the corresponding one or more industrial automation devices and a requesting data access service of the plurality of data access services using the respective stateful connections and the respective stateless connections.

15. The method of claim 14, wherein the receiving the data requests from the plurality of data access services further comprises using one of the stateful connections to facilitate the data transmission between the corresponding one or more industrial automation devices and multiple requesting data access services.

16. The method of claim 14, further comprising:
identifying, at the connection broker, concurrent requests for a same data requested from a same industrial automation device of the plurality of industrial automation devices;
obtaining the same data corresponding to the concurrent requests once; and
transmitting the same data corresponding to the concurrent requests to each data access service of the plurality of data access services associated with the concurrent requests.

17. The method of claim 14, further comprising:
determining, at the connection broker, that one of the stateful connections to one of the plurality of industrial automation devices is beyond a connection capacity threshold; and
in response to determining that one of the stateful connections to one of the plurality of industrial automation devices is beyond the connection capacity threshold, establishing, at the connection broker, another stateful connection to the one of the plurality of industrial automation devices.

18. The method of claim 14, wherein:
the method is executed in an environment comprising a distributed data storage system having a plurality of nodes;
the connection broker spans the plurality of nodes; and
maintaining the stateless connections between the connection broker and the plurality of data access services further comprises establishing, at the connection broker, stateless connections to any access services hosted on the plurality of nodes.

19. The method of claim 18, the method further comprising:
determining, at the connection broker, that one of the stateful connections between the connection broker and an industrial automation device of the plurality of industrial automation devices is failing; and
in response, establishing a new stateful connection between the connection broker and the industrial automation device.

20. The method of claim 14, wherein:
the connection broker comprises a plurality of containers;
each container of the plurality of containers has a container type;
the container type comprises one of a device-specific container, a device-type-specific container, a data-type-specific container, a workload-specific container, or a combination thereof; and
the receiving the data requests from the plurality of data access services further comprises receiving, at each container of the plurality of containers, the data requests, wherein the data requests correspond to the container type of each container of the plurality of containers, respectively.
